(19) United States
(12) Patent Application Publication
(10) Pub. No.: US 2018/0182025 A1
(43) Pub. Date: Jun. 28, 2018

(54) SYSTEMS AND METHODS FOR VISUALIZING IN-BUDGET PRODUCTS AND SERVICES

(71) Applicant: CAPITAL ONE SERVICES, LLC, McLean, VA (US)

(72) Inventors: Justin Smith, Chicago, IL (US); Karen Nickerson, Chicago, IL (US); Justin Wishne, Chicago, IL (US); Drew Jacobs, Arlington, VA (US); Marco S. Giampaolo, Berwyn, IL (US); Hannes Jouhikainen, Arlington, VA (US)

(21) Appl. No.: 15/664,768

(22) Filed: Jul. 31, 2017

Related U.S. Application Data
(60) Provisional application No. 62/437,702, filed on Dec. 22, 2016.

(51) Int. Cl. G06Q 30/06; G06Q 40/00

(52) U.S. Cl. CPC G06Q 30/0643; G06Q 40/12; G06Q 30/0623

(57) ABSTRACT

A system includes one or more memory devices storing instructions, and one or more processors configured to execute the instructions to perform steps of a method. The system may provide an augmented environment for visualizing one or more in-budget products or services. The system may store profile data that may include budget information. The system may then receive environmental data, and identify one or more action items in the environmental data. The system may determine a budgetary classification of a first action item and generate virtual environment data including enhanced content. The system may then provide the virtual environmental data to a computing device to create an augmented environment, wherein the enhanced content is provided for display in association with the first action item.

### CROSS-REFERENCE TO RELATED APPLICATION

This application claims the benefit of U.S. Provisional Application No. 62/437,702, filed 22 Dec. 2016, the entire contents and substance of which is hereby incorporated by reference.

### FIELD OF INVENTION

The present disclosure relates to systems and methods for generating visual displays, i.e., visualizing, in-budget products and services, and more particularly systems and methods for visualizing budget-related information associated with products and services in an interactive augmented or virtual environment.

### BACKGROUND

Typically, when a shopper sets out to buy goods or services, the shopper is well-advised to limit the price they are willing to spend on a particular item or class of items in accordance with a budget. That is, the budget may designate the maximum spending allowance towards a particular item or class of items over a specified time period (e.g., $10 on coffee at the local coffee shop this week, $500 on groceries this month, $200 on jeans this year, etc.). Staying within budget helps the purchaser to spend within their means and save to meet long-term financial goals.

Despite the importance of making and adhering to a budget, it is often difficult, inconvenient, or impractical for even the most disciplined shopper to make and keep track of their budget as they shop at a merchant location or even online. Maintaining the budget throughout the shopping experience requires that the shopper iteratively update the budget by keeping track of expenditures, anticipating future purchasing needs, and aligning those expenditures and future purchasing needs with the purchaser's income and long-term budget goals. While some existing software products make it easier to track expenses and monitor a budget, these products do not passively provide real-time budgetary advice on a purchase by purchase basis as a consumer is viewing items and contemplating purchasing decisions.

Accordingly, there is a need for systems and methods for visualizing in-budget products and services. Such systems can be non-invasive to the shopper's day by passively providing budgetary information and advice as to whether a particular product or service is within budget, suggestions of cheaper alternatives, or even confirmation when a particular product or service is a good deal for achieving long-term budget goals. Embodiments of the present disclosure are directed to this and other considerations.

### SUMMARY

Disclosed embodiments provide systems and methods for visualizing in-budget products and services using augmented reality.

Consistent with the disclosed embodiments, the system may include one or more memory devices storing instructions, and one or more processors configured to execute the instructions to perform steps of a method for visualizing one or more in-budget products or services. The system may store profile data including user profile information (e.g., user login information, user budget information, user payment information, etc.). The system may then receive environmental data representing a physical environment (e.g., a merchant location) from a computing device (e.g., a purchaser's mobile device), and identify one or more action items in the environmental data that are associated with one or more products (e.g., shoes) or services (e.g., haircut) in the physical environment. Based on this identification, the system may determine a budgetary classification of a first action time based on the profile data and generate virtual environmental data comprising enhanced content (e.g., an in-budget or out-of-budget indication) associated with the first action item. The system may then provide the virtual environmental data to the computing device to create an augmented environment in combination with the physical environment, with the enhanced content being provided for display in association with the first action item.

Consistent with the disclosed embodiments, systems and methods for visualizing in-budget products and services using virtual reality are also provided.

Further features of the disclosed design, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an exemplary system that may be used to generate an augmented environment for visualizing in-budget products or services;

FIG. 2 is a component diagram of an exemplary service provider terminal;

FIG. 3 is a flowchart of an exemplary method for generating an augmented environment for visualizing in-budget products or services;

FIG. 4 is a flowchart of an exemplary method for generating a virtual environment for visualizing in-budget products or services;

FIG. 5 is a diagram of exemplary types of virtual environmental data;

FIG. 6 is an exemplary display of an embodiment of a computing device; and

FIG. 7 is a component diagram of an exemplary computing device.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The disclosed embodiments are directed to systems and methods for visualizing one or more in-budget products and services. The system may include one or more memory devices storing instructions, and one or more processors configured to execute the instructions to perform steps of a method. Specifically, in some embodiments, the system may provide an augmented environment for visualizing in-budget products and services. To accomplish this, the system may execute the instructions to store profile data including user profile information. The system may then receive environmental data representing a physical environment from a computing device, and identify one or more action items in the environmental data. The action item(s) may be associated with one or more products or services in the physical environment. Based on this identification, the system may determine a budgetary classification of a first action item based on the profile data, and generate virtual environmental data comprising enhanced content associated with the first action item. The enhanced content may be unrepresented in the physical environment. The system may then provide the virtual environmental data to the computing device to create an augmented environment in combination with the physical environment. In providing the virtual environmental data to the computing device, the enhanced content may be provided for display in association with the first action item.

In another embodiment, a system for visualizing one or more in-budget products or services that may be used to assist a user in making purchasing decisions may include a memory for storing profile data comprising user profile information. The system may include an environmental data sensor for obtaining environmental data comprising audio and/or visual information representing a physical environment. The system may include a geographic location sensor associated with the environmental data sensor for obtaining location data associated with the physical environment and an input/output device for receiving merchant data from a merchant database. The merchant database may include data associated with merchants located at a specific geographic location. The system may further include an augmented environment processor that, based on environmental data obtained by the environmental data sensor, may identify one or more action items associated with one or more products or services in the physical environment, determine merchant data stored in the merchant database that is associated with the one or more action items, determine a budgetary classification of a first item of the one or more action items based on the profile data and merchant data, integrate the merchant data with the environmental data to create augmented environmental data comprising enhanced content associated with the first action item, and generate a signal comprising augmented environmental data. In some embodiments, the enhanced content may be content that is unrepresented in the physical environment. The system may also include an augmented environmental data display that receives the signal comprising augmented environmental data and displays said augmented environmental data in accordance with said signal.

In another aspect, a non-transitory computer-readable medium storing instructions is disclosed. The instructions, when executed by one or more processors, may cause a computing device to perform steps of a method for visualizing one or more in-budget products and services. Specifically, the computing device may store profile data including user payment or other profile information and receive environmental data representing a physical environment from a computing device. The computing device may then identify one or more action items in the environmental data. The action item(s) may be associated with one or more products or services in the physical environment. Based on this identification, the computing device may determine a budgetary classification of a first action item based on the profile data, and generate virtual environmental data comprising enhanced content associated with the first action item. The enhanced content may be unrepresented in the physical environment. The computing device may then provide the virtual environmental data (e.g., to a user's computing device or a mobile device in communication with the computing device) to create an augmented environment in combination with the physical environment. In providing the virtual environmental data, the enhanced content may be provided for display in association with the first action item.

In another aspect, another system for visualizing one or more in-budget products or services is disclosed. The system may include one or more memory devices storing instructions, and one or more processors configured to execute the instructions to perform steps of a method. Specifically, in some embodiments, the system may provide a virtual environment for visualizing in-budget products and services. To accomplish this, the system may execute the instructions to store profile data including user profile information. The system may then receive virtual environmental data from a computing device (e.g., a computing device associated with a merchant), and identify one or more action items in the virtual environmental data. The action item(s) may be associated with one or more products or services offered for sale by a merchant. Based on this identification, the system may determine a budgetary classification of a first action item based on the profile data, and generate enhanced content associated with the first action item. The enhanced content may be unrepresented in the virtual environmental data as received. The system may then provide the virtual environmental data to a computing device to create a virtual environment. In providing the virtual environmental data to the computing device, the enhanced content may be provided for display in association with the first action item.

In another aspect, a non-transitory computer-readable medium storing instructions is disclosed. The instructions, when executed by one or more processors, may cause a computing device to perform steps of a method for visualizing one or more in-budget products and services. Specifically, the computing device may store profile data including user payment or other profile information. The computing device may then receive virtual environmental data (e.g., from a computing device associated with a merchant), and identify one or more action items in the virtual environmental data. The action item(s) may be associated with one or more products or services offered for sale by a merchant. Based on this identification, the computing device may determine a budgetary classification of a first action item based on the profile data, and generate enhanced content associated with the first action item. The enhanced content may be unrepresented in the virtual environmental data as received. The computing device may then provide the virtual environmental data (e.g., to a user's computing device or a mobile device in communication with the computing device) to create a virtual environment. In providing the virtual environmental data, the enhanced content may be provided for display in association with the first action item.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

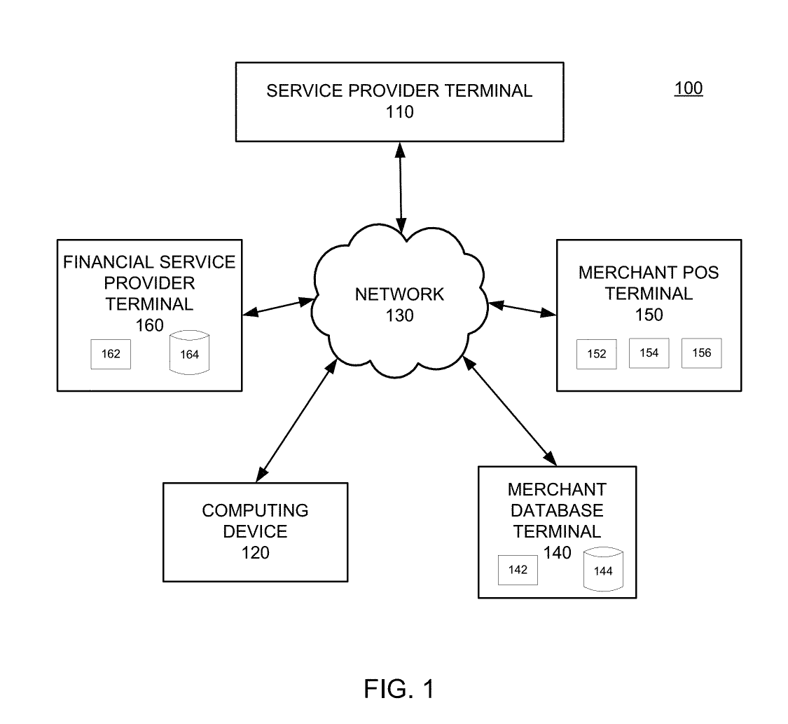

FIG. 1 is a diagram of an exemplary system that may be configured to perform one or more processes to generate an augmented environment for visualizing in-budget products and services. The components and arrangements shown in FIG. 1 are not intended to limit the disclosed embodiments as the components used to implement the disclosed processes and features may vary.

In accordance with disclosed embodiments, in-budget visualizing system 100 may include a service provider terminal 110 in communication with a computing device 120 via network 130. In some embodiments, service provider terminal 110 is also in communication with a merchant database terminal 140 via network 130. Computing device 120 may include a mobile computing device (e.g., a smart phone, tablet computer, smart wearable device, portable laptop computer, voice command device, or other mobile computing device) or a stationary computing device (e.g., a stationary desktop or other stationary computer). Computing device 120 may belong to or be provided by a consumer, or may be borrowed, rented, or shared. In some embodiments, computing device 120 may be configured to provide one or more of an augmented reality and a virtual reality experience to one or more users, and may be equipped with a visual display, speakers or other auditory devices, tactile simulators, and other devices configured to engage the user's senses to enhance the augmented/virtual reality experience.

In some embodiments, in-budget visualizing system 100 may connect to a merchant database terminal 140 that communicates with other devices of system 100 via network 130. Optionally, in some embodiments, in-budget visualizing system 100 may also include a merchant point of sale (POS) terminal 150 that communicates with other devices of system 100 via network 130. Additionally, in some embodiments, in-budget visualizing system 100 may also include a financial service provider terminal 160 that communicates with other devices of system 100 via network 130.

Network 130 may be of any suitable type, including individual connections via the internet such as cellular or WiFi networks. In some embodiments, network 130 may connect terminals using direct connections such as radio-frequency identification (RFID), near-field communication (NFC), Bluetooth™, low-energy Bluetooth™ (BLE), WiFi™, ZigBee™, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

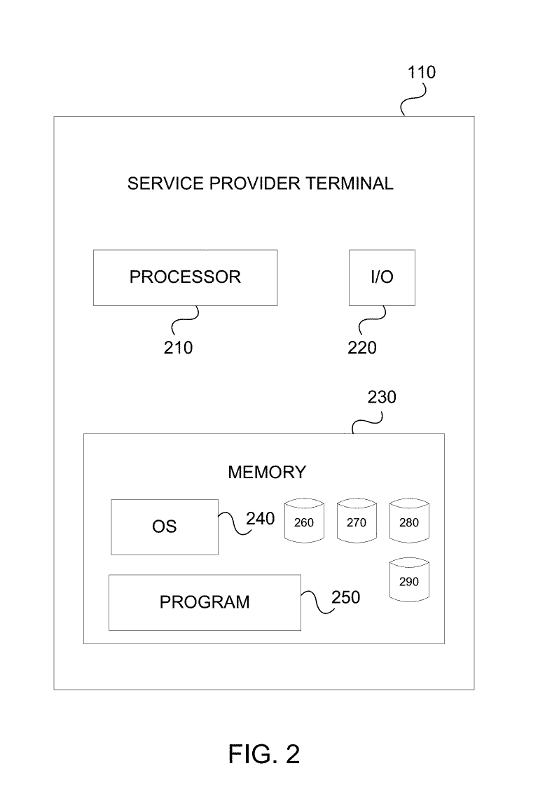

An exemplary embodiment of service provider terminal 110 is shown in more detail in FIG. 2. Computing device 120, merchant database terminal 140, merchant POS terminal 150, and financial service provider terminal 160 may have a similar structure and components that are similar to those described with respect to service provider terminal 110. As shown, service provider terminal 110 may include a processor 210, an input/output (“I/O”) device 220, a memory 230 containing an operating system (“OS”) 240 and a program 250. For example, service provider terminal 110 may be a single server or may be configured as a distributed computer system including multiple servers or computers that interoperate to perform one or more of the processes and functionalities associated with the disclosed embodiments. In some embodiments, the service provider terminal 110 may further include a peripheral interface, a transceiver, a mobile network interface in communication with the processor 210, a bus configured to facilitate communication between the various components of the service provider terminal 110, and a power source configured to power one or more components of the service provider terminal 110.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another network. In some embodiments, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Service provider terminal 110 may include one or more storage devices configured to store information used by processor 210 (or other components) to perform certain functions related to the disclosed embodiments. In one example, service provider terminal 110 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, service provider terminal 110 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, service provider terminal 110 may include memory 230 that may include one or more programs 250 to perform one or more functions of the disclosed embodiments. Moreover, processor 210 may execute one or more programs 250 located remotely from system 100. For example, system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 230 may include software components that, when executed by processor 210, perform one or more processes consistent with the disclosed embodiments. In some embodiments, memory 230 may include a merchant information database 260, an environment database 270, a virtual environmental database 280, and a user profile database 290 for storing related data to enable service provider terminal 110 to perform one or more of the processes and functionalities associated with the disclosed embodiments. Merchant information database 260 may include stored data relating to product price, product inventory, related products, and available discounts associated with one or more products associated with one or more merchants. Environment database 270 may include stored data relating to a physical environment that is captured by one or more devices (e.g., computing device 120) of system 100. Virtual environment database 280 may include stored data relating to a virtual environment that is provided to and can be updated based upon interactions with one or more devices (e.g., computing device 120) of system 100. User profile database 290 may include stored data relating to one or more users, including information such as user identification information (which may include information sufficient to identify one or more devices of a user), user payment information and credentials, user budget information, user purchase history, user purchaser preferences, user spending habits, user delivery locations, merchant account numbers, user coupons and/or discounts, and other information about a user's finances or spending habits.

Service provider terminal 110 may also be communicatively connected to one or more memory devices (e.g., databases (not shown)) locally or through a network. The remote memory devices may be configured to store information and may be accessed and/or managed by service provider terminal 110. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

Service provider terminal 110 may also include one or more I/O devices 220 that may comprise one or more interfaces for receiving signals or input from devices and providing signals or output to one or more devices that allow data to be received and/or transmitted by service provider terminal 110. For example, service provider terminal 110 may include interface components, which may provide interfaces to one or more input devices, such as one or more keyboards, mouse devices, touch screens, track pads, trackballs, scroll wheels, digital cameras, microphones, sensors, and the like, that enable service provider terminal 110 to receive data from one or more users (such as via computing device 120).

In exemplary embodiments of the disclosed technology, service provider terminal 110 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While service provider terminal 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the terminal 110 may include a greater or lesser number of components than those illustrated.

Merchant database terminal 140 may have one or more processors 142 and one or more merchant databases 144, which may be any suitable repository of merchant data. Merchant database terminal 140 may be located at the POS location, off-site at another merchant location, or at a third party location. Information stored in merchant database terminal 140 may be accessed (e.g., retrieved, updated, and added to) via network 130 by one or more devices (such as service provider terminal 110) of system 100. Merchant database 144 may store information relating to products and services offered by merchants such as pricing, quantity, availability, discounts, reviews, and any other such generally available information that a consumer may utilize in making a purchasing decision. In some embodiments, merchant database 144 may also include location information associated with products and services that identifies the location(s) that a particular product or service is available for purchase. In some embodiments, the location information may include an identification of a particular store, terminal, or kiosk that the product or service may be purchased from.

Merchant POS terminal 150 may have one or more POS devices 152, 154, 156 that communicate with one or more devices (e.g., computing device 120) of system 100 via network 130. In some embodiments, POS devices 152, 154, 156 may be associated with one or more products or items at a POS location, and may serve as beacons to identify the associated products or items and related information to one or more devices of system 100. In other embodiments, merchant POS terminal 150 may be configured to process online transactions on behalf of the associated merchant.

Financial service provider terminal 160 may have one or more processors 162 and one or more financial service provider databases 164, which may be any suitable repository of merchant data. Financial service provider terminal 160 may be located at the POS location, off-site at another financial service provider location, or at a third party location. Information stored in financial service provider database 164 may be requested and sent to one or more devices (e.g., service provider terminal 110, merchant POS terminal 150) of system 100 via network 130.

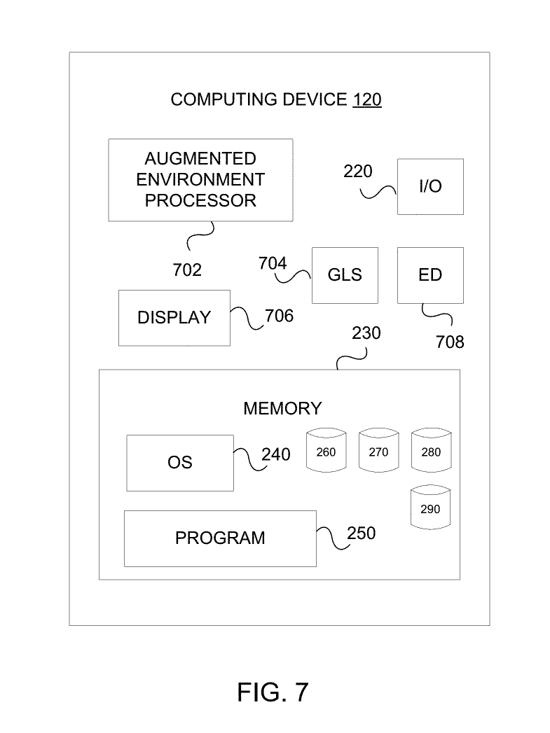

FIG. 7 shows an exemplary embodiment of computing device 120. As shown, computing device 120 may include input/output (“I/O”) device 220, memory 230 for storing profile data and containing operating system (“OS”) 240 and program 250 and all associated components as described above with respect to service provider terminal 110. Computing device 120 may also have one or more processors, including an augmented environment processor 702 for generating signals representative of augmented and/or virtual environments, a geographic location sensor (“GLS”) 704 for determining the geographic location of computing device 120 and/or an associated environmental data sensor 708, an augmented environmental data display 706 for displaying augmented environmental data, and an environmental data (“ED”) sensor 708 for obtaining environmental data including audio and/or visual information representing a physical environment. In some embodiments, environmental data sensor 708 may include a microphone or a digital camera. According to some embodiments, augmented environment processor 702 may include all of the features and functions of processor 210 described above. Further, augmented environment processor 702 may be configured to identify one or more action items associated with one or more products or services in the physical environment based on environmental data obtained by the environmental data sensor 708. For example, augmented environment processor 702 may use image recognition techniques to identify an item present in the physical environment and associate the identified item with an action item. Enhanced content may be content that is unrepresented in the physical environment. The augmented environment processor 702 may determine merchant data stored in a merchant database 144 that is associated with one or more action items. In some embodiments, the augmented environment processor may determine merchant data stored in the merchant database that is associated with the one or more action items based on location data obtained by the geographic location sensor 704. Based on the merchant data and the profile data, the augmented environment processor 702 may determine a budgetary classification of a first item of the one or more action items. The augmented environment processor 702 may create augmented environmental data comprising enhanced content associated with the first action item by integrating the merchant data with the environmental data. The augmented environment processor 702 may then generate a signal comprising augmented environmental data that may be sent to augmented environmental data display 706 to display the augmented environmental data in accordance with the signal. In some embodiments, an augmented environment data signal may be used to create an augmented reality display of the physical environment that may display budgetary information in association with one or more items present in the physical environment.

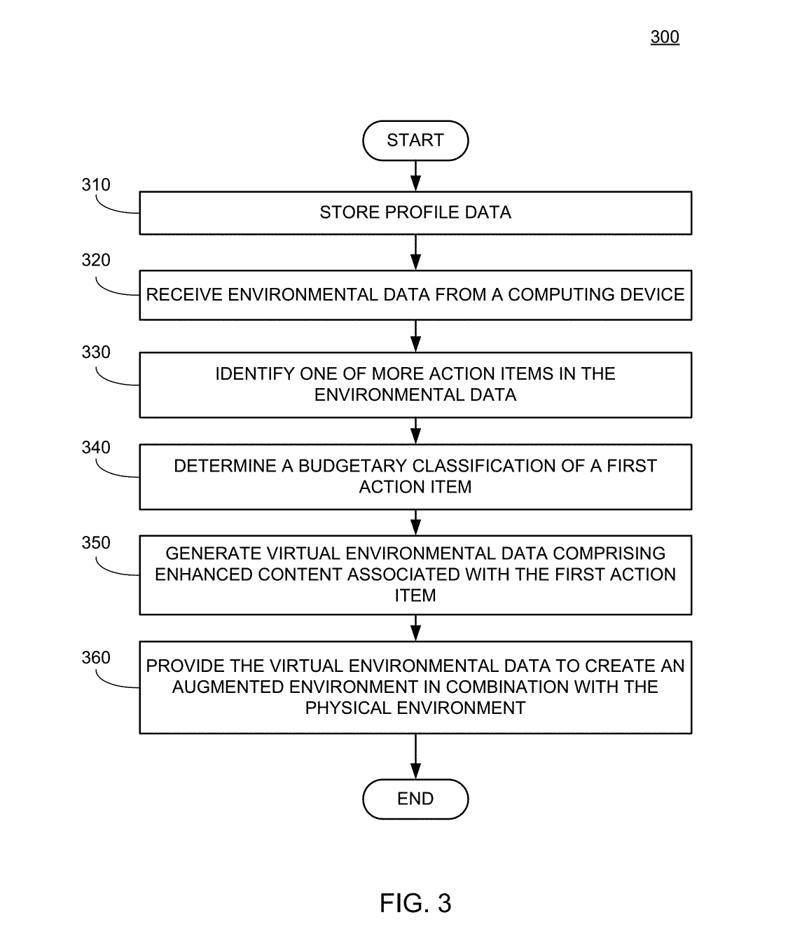

FIG. 3 shows a flowchart of method 300 for generating an augmented environment and visualizing (i.e., providing a visual display of) one or more in-budget products or services. In-budget products and services may be products or services that are available for purchase that fall within a user's budget. For example, in-budget products and services may be products and services that have a price that meets one or more predetermined budgetary constraints (e.g., a maximum price for a certain type of item). Method 300 may be performed by service provider terminal 110 using processor 210 to execute memory 230. In some embodiments, one or more steps of method 300 may be delegated to other devices or systems in system 100, such as computing device 120, merchant database terminal 140, merchant POS terminal 150 and/or financial service provider terminal 160. Following method 300, user(s) may generate, share, and modify virtually augmented environments.

In block 310, service provider terminal 110 may store profile data. Profile data may include information such as user profile information, user budget information, coupon/discount information, and/or payment credentials. Profile data may be entered or updated directly by a user (e.g., via computing device 120 or merchant POS terminal 150), or stored on and retrieved from merchant database terminal 140 or financial service provider terminal 160. User profile information can include delivery locations, user preferences for goods and services, merchant account numbers, goods and services purchased by the user, and goods and services viewed by the user. User budget information may include data indicative of a maximum amount of money that may be spend on a particular item or class of items (e.g., corresponding to one or more action items) that correspond to one or more of a predetermined time limit, a predetermined merchant, or a predetermined physical location. Budget information may include data indicative of a maximum amount of money that may be spent on one or more items or classes of items. For example, given a budgeted amount for clothing, budget information may include the maximum amount a user may spend on clothing without exceeding a budget, or if an item were purchased how long until the clothing budget category would again have budgeted resources to support purchase of another piece of clothing. Similar characterizations may be utilized for groceries, restaurant expenses in a given month, or any other goods or services for which a budget had been established. It should be understood that budget information may be presented in many forms, for example, purchase allowances may be associated with any time frame, any type of good or service, a particular merchant, a particular physical location, or may be otherwise customized in a variety of ways. Payment credentials may include payment card information or financial account information (e.g., which may be associated with financial service provider terminal 160) or other financial information as needed to initiate and authorize a payment.

At step 320, service provider terminal 110 may receive environmental data comprising audio and visual information via computing device 120. Having received the environmental data, at step 330 service provider terminal 110 may identify one or more action items in the visual information of the environmental data. Action items can be identified by recognizing shapes or materials, bar codes, QR codes, IR beacons or Bluetooth™ beacons located in an environment or included with an item (e.g., POS devices 152, 154, and 156 associated with one or more products or items at a POS location or devices associated with different predefined areas of a closet, refrigerator, pantry, etc. that stores items that are periodically repurchased), RFID/NFC tags, or the like. According to some embodiments, the service provider terminal 110 may identify a particular item as an action item after when the item has been the visual focus of computing device 120 (e.g., within computing device's 120 field of view) for a predetermined period of time or after a predetermined threshold of user blinking has been detected by computing device 120. Examples of action items may include products or services in a physical environment, including products or services offered for sale by a merchant or another user or other products or services that were previously purchased by the user or another user.

At step 340, service provider terminal 110 may determine a budgetary classification of a first action item of the one or more action items based on the profile data. A budgetary classification may provide useful budgetary or purchasing information about a product or service associated with the action item that a user may utilize to make an informed (or budget-conscious) purchasing decision, and made be customized based on one of the predetermined modes of operation that one or more devices of system 100 (e.g., service provider terminal 110) may be operating in. For example, when operating in save money mode, determining a budgetary classification may include generating an alternative product determination, which may indicate whether the price associated with the first action item exceeds the price of an alternative item. In some embodiments, when operating in budget mode, determining a budgetary classification may including generating an in-budget determination that indicates whether a price associated with the first action item exceeds or fails to exceed a predetermined threshold associated with the user budget information. Further, when operating in tally mode, determining a budgetary classification may include generating a historical spend determination that may represent an amount that a user associated with computing device 120 has previously spent on a particular item or item category during a specified period. Further, when operating in ambient mode, determining a budgetary classification may include generating an on-sale determination that indicates that a particular item is on sale or that a coupon is available to reduce the price of the item. For example, service provider terminal 110 may access the user profile database 290 to access any stored coupons or discounts the user has and the service provider terminal 110 may alert the user (e.g., by sending an alert to computing device 120) when the user if viewing an item (e.g., using computing device 120) that the user has an associated coupon or discount for. It is contemplated that a user may provide mode selection input (e.g., via computing device or merchant POS terminal 150) to system 100 before or during use, or that system 100 may operate in a default mode unless a receiving an alternative mode selection.

In block 350, service provider terminal 110 may generate, based on the environmental data and the determined budgetary classification, virtual environmental data comprising enhanced content associated with the first action item. Enhanced content may include content that is unrepresented in the physical environmental. For example, in some embodiments, enhanced content may include a price of an item, wherein the price is not actually listed in the physical environment. In some embodiments, enhanced content may include item price history, user purchase history, social information, ratings/reviews, or commentary or opinions from friends on an item. According to some embodiments, social information may include whether social media contacts, celebrities, or other users have purchased an item or expressed a desire to purchase an item. In some embodiments, social information may include communications with friends or contacts. For example, in some embodiments, the system 100 may facilitate communications with other people that may allow a user to, for example, ask a friend's advice about an item they are viewing and receive text messages, voice messages, or images from the friend to aid in the user's purchasing decision. In other embodiments, enhanced content may include the price of an item in a particular color or particular aesthetic effect to convey addition meaning (e.g., in-budget vs. out-of-budget) beyond the price itself, regardless of whether the price is shown in the physical environment. In some embodiments, enhanced content may include information related to alternative items (e.g., cost, product information, and availability for the alternative items). In other embodiments, enhanced content may include spending pattern information (e.g., budget trends over a specified period of time) or savings progress and goal information (e.g., an indication of how the lower cost of a particular item may contribute to savings goals). Further, in other embodiments, enhanced content may include coupon or on-sale information related to the identified item and/or to alternative items. Enhanced content and virtual environmental data may be generated by recognizing items (i.e., action items) in the environmental data and accessing information relating to the items. For example, according to some embodiments, service provider terminal 110 may recognize a particular item in the environmental data, such as a particular product or service that is being offered for sale or is present in the physical environment around computing device 120. Service provider terminal 110 can connect to an appropriate merchant database terminal 140 to include information relevant to the identified action item. For example, in the event that the identified action item is a cable box, service provider terminal 110 may connect to a cable provider database terminal (e.g., merchant database terminal 140), or in the event that the action item is a food item, service provider terminal 110 may connect to a grocery store database terminal (e.g., merchant database terminal 140).

Enhanced content may include a message, image, or icon for display in association with one or more action items that represents, for example, that an item is in-budget, that an item is out-of-budget, that an item is on sale, that a coupon or discount for the item exists, or that an item is cheaper or more expensive than one or more alternative items. Accordingly, the virtual environmental data may include product price or bill amount information, bill due date, product inventory information, user purchase history information (e.g., information related to previous purchases of the same or similar items), social information (e.g., whether a social media contact has purchased the item), ratings/reviews, related products (e.g., other brands, sizes, or models), available discounts, aesthetic visual effects (e.g., target graphics, glow, highlighted colors, changed color scheme between an identified product or service and other items or background, or firework graphics displayed around one or more products to draw attention to a particular item or to convey a message associated with that item, such as being highlighted red for being an item that is out-of-budget), and budget information (e.g., an message or symbol indicative that the identified product or service is in-budget or out-of-budget).

In block 360, the service provider terminal 110 may provide the virtual environmental data to computing device 120 in order to create an augmented environment when viewed in combination with the physical environment, with the enhanced content being provided for display in association with the first action item (e.g., such that a user viewing the augmented environment sees the enhanced content in association with—nearby, overlaying, etc.—the product or service in the physical environment that is associated with the first action item). In some embodiments, the virtual environment data may include some or all of the environmental data provided by computing device 120. Accordingly, in this way, the service provider terminal 110 may provide data to the computing device 120 that will allow the computing device to display enhanced content to a user in an augmented environment that may inform the user as to whether a particular product or service of interest is within the user's budget, has less expensive alternatives, is on-sale or otherwise discounted (e.g., based on a coupon that the user has), or is otherwise a good deal that helps the user meet short-term or long-term budget goals. Although this disclosure is generally directed towards providing a visualization of in-budget products and services (i.e., a visual display to notify the user), it should be understood that embodiments of the present disclosure may provide budgetary feedback that is non-visual. For example, in some embodiments, budgetary notifications may be provided by auditory (e.g., computing device 120 may make a sound), haptic (e.g., computing device 120 may vibrate), or olfactory cues (e.g., computing device 120 may emit a smell) to indicate that a particular item is in-budget or out-of-budget.

In some embodiments, the service provider terminal 110 may receive user input data associated with the first action item from the computing device 120 and, in response, provide a purchase request to the merchant terminal 150 to enable a transaction related to the first action item. The user input data may correspond with one or a plurality of pre-defined user inputs (e.g., a voice command, a hand gesture or other movement, or sequence of buttons or keys provided via computing device 120). In some embodiments, the purchase request may include purchase request data that includes the stored user payment credentials. According to some embodiments, the service provider terminal 110 may withhold providing the purchase request to the merchant terminal 150 based on an in-budget determination. For example, if an in-budget determination indicates that a particular action item is outside of a user's budget (e.g., by being too expensive to meet predetermined short-term or long-term budget goals, by not being on sale or discounted beyond a predetermined threshold percentage or value, or by having cheaper alternative items that are available online or within a predetermined location area), service provider terminal 110 may prevent the user from purchasing the item. For example, if a user attempts to purchase an item that the system 100 has determined is out of the user's budget, system 100 may provide a warning indication to the user by, for example, playing sound, flashing a visual warning, or causing a haptic signal (e.g., a vibration) to occur at the computing device 120. According to some embodiments, computing device 120 may be a wearable device (e.g., a mobile phone, smart watch, wearable headset) that may provide the warning indication to a user. In some embodiments, the system 100 may cause a warning indication to be delivered by a peripheral device located in the environment of the user.

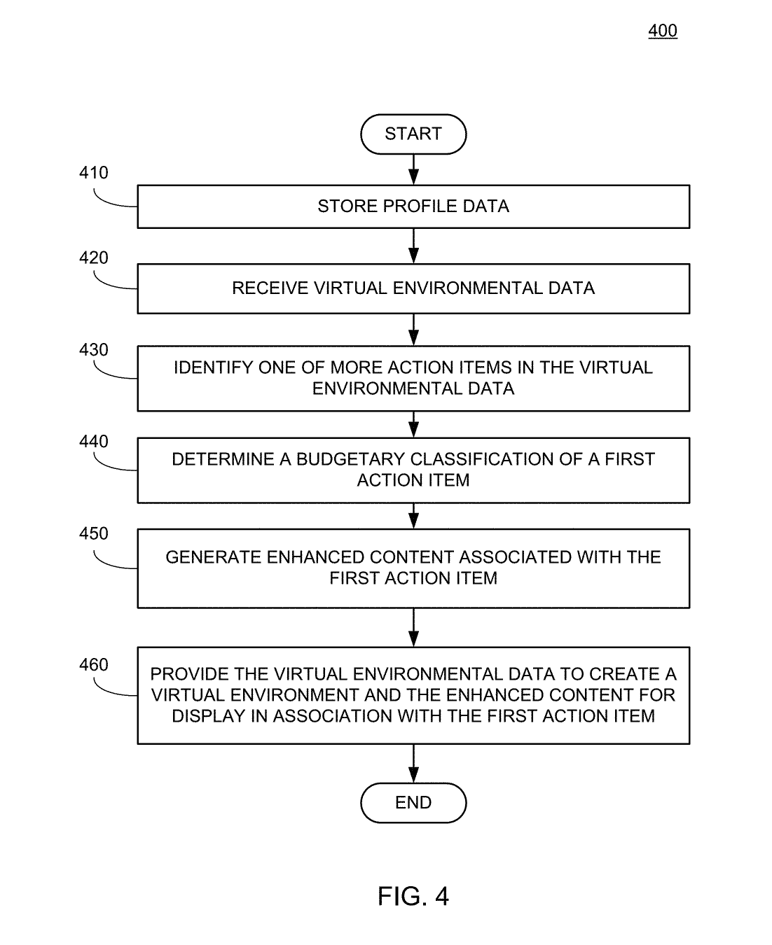

FIG. 4 shows a flowchart of method 400 for generating a virtual environment for visualizing in-budget products and services, and may include one or more steps that overlap with similar steps in method 300. In block 410, service provider terminal 110 may store profile data similar to that of step 310 in method 300 as described above. In block 420, service provider terminal 110 may receive virtual environmental data from, for example, a computing device associated with a merchant (e.g., merchant database terminal 140 or merchant POS terminal 150), a financial service provider (e.g., financial service provider terminal 160), or a third party. In block 430, service provider terminal 110 may identify one or more action items in the virtual environmental data in a similar fashion as identifying one or more action items in environmental data as described above in step 330 of method 300. In block 440, service provider terminal 110 may determine a budgetary classification of a first action item of the one or more action items based on the profile data in a similar fashion as described above in step 340 of method 300. In block 450, the service provider terminal 110 may generate enhanced content associated with the first action item, wherein the enhanced content is unrepresented in the virtual environmental data as received. In some embodiments, the enhanced content may overlap with the enhanced content generated in step 350 of method 300 as described above. Additionally, in block 460, the service provider terminal 110 may provide the virtual environmental data to a computing device associated with the user profile information (e.g., to computing device 120) to create a virtual environment, with the enhanced content being provided for display in association with the first action item in a similar fashion as providing the virtual environmental data to create an augmented environment as described above in step 360 of method 300.

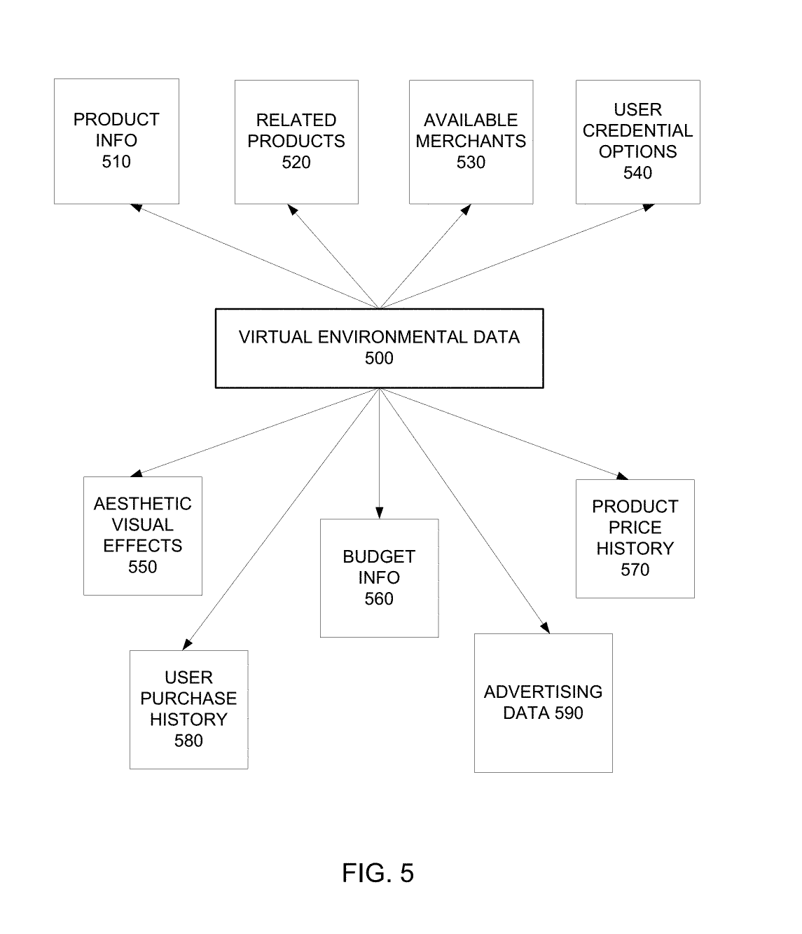

FIG. 5 shows a diagram that represents an embodiment of exemplary types of virtual environmental data 500. For example, virtual environmental data 500 may include product price information 510 (e.g., which may include the listed price of a product or service or the price provided on a bill associated with a product or service), related product information 520 (e.g., alternative products and their price, description, availability, etc.), product availability between merchants 530 (e.g., the merchant location of available products or services, available time slots for a particular service, online product availability and delivery time, etc.), user credential options 540 (e.g., associated with payment options to purchase the identified products or services), aesthetic visual effects 550, budget information 560, product price history 570 (e.g., data indicating previous sales prices of the item), user purchase history 580 (e.g., data indicating whether a user has bought the item in the past, where it was bought, when it was bought, and how much was paid), and advertising data 590 (e.g., merchant content such as coupons, discounts, advertized alternative products, etc.). According to some embodiments, advertising data 590 may be provided to the service provider terminal 110 by a merchant database terminal 140 or merchant POS terminal 150. By including advertizing data 590 in the virtual environment data 500, the system 100 may enable merchants to promote certain items, advertize discounts, coupons, or incentives, or to advertize alternative or related products and services when a user is viewing a particular item. For example, if a user is viewing a car, the system 100 may cause an advertisement for car insurance to be displayed to the user (e.g., via computing device 120). According to some embodiments, advertising data 590 may be provided by a plurality of merchants such that a user may be presented with multiple offers when viewing a particular item.

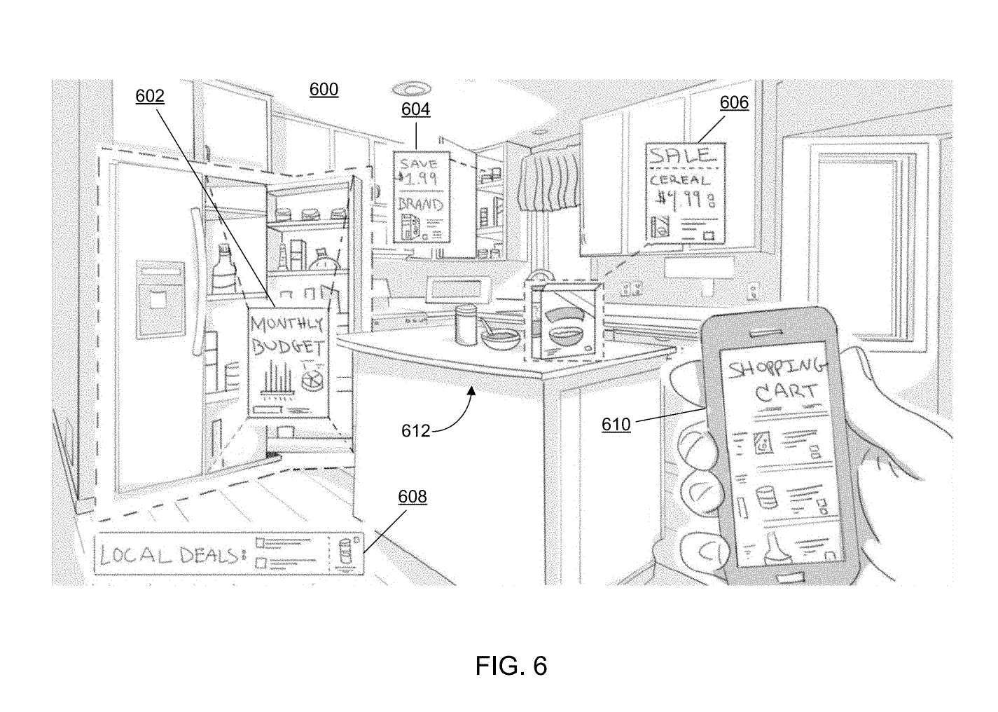

FIG. 6 shows an exemplary display of an embodiment of computing device 120. As shown, augmented environment 600, which may include, for example, budget information 602, alternative items 604, targeted advertisements 606, local information 608, and the like, is overlaid on environment 612 so that a user can view and interact with both real and virtual elements. System 100 may have various modes of operation, such as, for example, budget mode, save money mode, and ambient mode. According to some embodiments, when in budget mode, computing device 120 may display budget information 602 in relation to products or services in the field of view of computing device 120. For example, as shown in FIG. 6, displayed budget information 602 may provide graphs, charts, numbers, icons or images that are representative of the magnitude of spending on a particular item or class of items, or other data indicating how much money has been spent on the items in the budget category in relation to a monthly budget. In some embodiments, the displayed budget information 602 may show the price of a product and indicate whether the product falls within the budget of a user. In some embodiments, when in save money mode, computing device 120 may display alternative items 604, providing cheaper alternatives to a product identified in the field of view of computing device 120. For example, as described above, an item in the field of view of computing device 120 may be identified by recognizing shapes or materials, bar codes, QR codes, IR beacons or Bluetooth™ beacons located in an environment or included with an item, or RFID/NFC tags or the like. In some embodiments, when in ambient mode, computing device 120 may display targeted advertisements 606 in response to a product identified in the field of view of the computing device 120. In some embodiments, computing device 120 may display local information 608 that may provide an interface to view information about products and services that are within a predetermined distance of computing device 120. According to some embodiments, a mobile device 610 may be used to interact with virtual elements displayed by computing device 120, by enabling the selection of items in order to be placed in a virtual shopping cart (i.e., purchased) or to be placed on a watch list. In some embodiments, mobile device 610 may have all of the same components as a computing device 120. In some embodiments, mobile device 610 may be the same device as the computing device 120 that displays the virtual elements.

As used in this application, the terms “component,” “module,” “system,” “server,” “device,” and the like are intended to include a computer-related entity, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Exemplary Use Cases

The following example use case describes one example of a typical user flow pattern. It is intended solely for explanatory purposes and not in limitation. In some embodiments, a user within their own home may be looking to save money on already-purchased products, and may provide mode selection input (e.g., via computing device 120) to put system 100 in save-money mode if it is not already in that mode. The user may have profile information stored in the system (e.g., via service provider 110 or computing device 120) that includes historical transaction data on purchased items. With their mobile device (e.g., computing device 120), the user may be provided with an augmented environment while looking into their kitchen cabinets and refrigerator in the physical environment of their home. After looking at a cereal box in a cabinet for longer than a predetermined time threshold, the augmented environment seen by the user (e.g., via computing device 120) may include enhanced content indicative that the identified cereal box is more expensive than an alternative (e.g., a similar store-brand cereal box or the same type of cereal box offered for sale by another merchant or third party). For example, the user's mobile device (e.g., computing device 120) may display a message, an icon, a highlighted color, or some other visual cue in association with an item (e.g., the box of cereal) that there is an alternative item that is available for sale (e.g., via a merchant associated with merchant POS terminal 150 or online). Other information such as alternative product pricing, delivery options, and purchasing options may also be displayed. An option to purchase this item from a retailer may also be displayed.

Another example use case relates to shopping for items, whereby a user can use their mobile device such as an augmented reality headset device (e.g., computing device 120) to view a particular set of items in a store and the mobile device may passively display budgetary information relating to each identified item to help a user stay on budget. The user may be shopping for products or services at a POS location, and may provide mode selection input (e.g., via computing device 120) to put system 100 in budget mode if it is not already in that mode. The system 100 may utilize the stored budget information associated with the user or the user may set a temporary budget for the shopping trip (e.g., at a particular merchant location or for a predetermined time). For example, the user may decide upon walking into a particular store that they only want to spend $100 in that store, and so they user may input a temporary budget into the system 100 via their mobile device (e.g., computing device 120). Upon entering the store, the user may be interested in buying a pair of shoes, and the system 100 could recognize the shoes being viewed by the user (e.g., via computing device 120), access product information (e.g., from the merchant database terminal 140) including price information, access the user's profile and budget information, make a determination (e.g., by service provider terminal 110) as to whether the shoes are within the user's budget, and then provide the user with an augmented environment via their mobile device (e.g., computing device 120) that displays a visual indication (e.g., highlighting the item, displaying an icon by the item, etc.) in association with the identified pair of shoes to indicate whether the shoes are within the user's budget. For example, the user may be looking at a wall of shoes and each pair of shoes that is within the user's budget may be highlighted in green, and each pair of shoes that are outside of the user's budget may be highlighted in red, faded, or changed to a black/white or grayscale color scheme. In this manner, system 100 may enable the user to quickly evaluate in real-time which items would be appropriate to purchase in accordance with the user's budget and which items should be off-limits.

Another example use case relates to a user shopping for items without utilizing a budget. In this case, the system (e.g., system 100) may still be used to assist the user in making purchasing decisions. For example, the user may activate a tally mode that may cause the system to display an amount that the user has spent on an item (or a class of items) over a specified period of time on the user's mobile device (e.g., computing device 120). Accordingly, as a user walks around a store, the user may be able to view previous spending on items so that even in the absence of a budget, the user may nonetheless be presented with data to inform a decision regarding whether or not to purchase an item. For example, if the user is looking at a pair of shoes, the system (e.g., system 100) may identify the item as shoes by, for example, image recognition techniques or detection of an RFID tag (e.g., by service provider terminal 110), access the user's purchase history and determine how much has been spent on shoes in the last year, and cause the user's mobile device (e.g., computing device 120) to display, for example, a message indicating that the user has spent $300 on shoes in the last year. The user may then use this information to decide whether or not to buying another pair of shoes is appropriate.

Another example use case relates to a user's ambient experience. For example, the user may not have a particular interest in purchasing an item, however, may be interested in being alerted when possible items of interest go on-sale or are otherwise discounted. The user may be walking through a public space with their mobile device (e.g., computing device 120), and may provide mode selection input (e.g., via computing device 120) to put system 100 in ambient mode if it is not already in that mode. The system 100 may detect (e.g., via computing device 120) nearby products or services that are on sale and may provide the user with an augmented environment via their mobile device (e.g., computing device 120) that visually notifies the user of the nearby on-sale products or services by displaying a visual indication on the mobile device. By virtue of the preferences set forth in the user's profile, the system 100 may know that the user is interested in, for example, corn flakes. The system 100 may become aware (by accessing, for example, merchant POS terminal 150) that corn flakes have gone on sale at a merchant location within a predetermined location area or online (e.g., via a merchant associated with merchant POS terminal 150), and the system 100 may provide the user with targeted advertisements or coupons on behalf of the merchant to inform the user of the sale, by, for example presenting a visualization of the sale or coupon on the mobile device (e.g., computing device 120).

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

1. A system for visualizing one or more in-budget products or services, comprising:
a memory for storing profile data comprising user profile information;
an environmental data sensor for obtaining environmental data comprising audio and/or visual information representing a physical environment;
an input/output device for receiving merchant data from a merchant database;
an augmented environment processor that, based on environmental data obtained by the environmental data sensor, identifies one or more action items associated with one or more products or services in the physical environment, determines merchant data stored in the merchant database that is associated with the one or more action items, determines a budgetary classification of a first item of the one or more action items based on the profile data and merchant data, integrates the merchant data with the environmental data to create augmented environmental data comprising enhanced content associated with the first action item, and generates a signal comprising augmented environmental data; and
an augmented environmental data display that receives the signal comprising augmented environmental data and displays said augmented environmental data in accordance with said signal,
wherein the enhanced content is unrepresented in the physical environment.

2. The system of claim 1, further comprising a geographic location sensor associated with the environmental data sensor for obtaining location data associated with the physical environment.

3. The system of claim 2, wherein the augmented environment processor determines merchant data stored in the merchant database that is associated with the one or more action items based on location data obtained by the geographic location sensor.

4. A system for visualizing one or more in-budget products or services, comprising:
one or more processors; and
a memory in communication with the one or more processors and storing instructions that, when executed by the one or more processors, are configured to cause the system to:
store profile data comprising user profile information;
receive, from a computing device associated with the stored profile data, environmental data comprising audio and visual information representing a physical environment;
identify one or more action items in the environmental data, the one or more action items being associated with one or more products or services in the physical environment;
determine a budgetary classification of a first action item of the one or more action items based on the profile data;
generate, based on the environmental data and determined budgetary classification, virtual environmental data comprising enhanced content associated with the first action item, wherein the enhanced content is unrepresented in the physical environment; and
provide, to the computing device, the virtual environmental data to create an augmented environment in combination with the physical environment, wherein the enhanced content is provided to the computing device for display in association with the first action item.

5. The system of claim 4, the system further storing instructions to cause the system to receive and store user budget information, wherein the stored profile data includes the user budget information.

6. The system of claim 5, wherein the user budget information includes data indicative of a maximum amount of money that may be spent on items corresponding to the one or more action items and one or more of a predetermined time limit, a predetermined merchant, or a predetermined physical location.

7. The system of claim 5, wherein the user budget information includes data indicative of a maximum amount of money that may be spent on one or more item classes of a plurality of item classes, the one or more action items each corresponding to one of the plurality of item classes.

8. The system of claim 5, wherein determining the budgetary classification further comprises generating an in-budget determination, and generating the in-budget determination includes determining that a price associated with the first action item exceeds or fails to exceed a predetermined threshold associated with the user budget information.

9. The system of claim 8, wherein the enhanced content further comprises an icon for display in association with the first action item.

10. The system of claim 8, wherein the stored profile data further comprises user payment credentials and the memory further storing instructions to cause the system to:
receive user input data associated with the first action item from the computing device; and
provide, based on the user input data, the first action item, and the user profile information, a purchase request comprising purchase request data to a merchant terminal to enable a transaction related to the first action item, the purchase request data comprising the stored user payment credentials.

11. The system of claim 10, wherein providing the purchase request further comprises withholding the purchase request based the in-budget determination.

12. The system of claim 4, wherein determining the budgetary classification further comprises generating an alternative product determination, and generating an alternative product determination includes determining that the price associated with the first action item exceeds a price of an alternative item.

13. The system of claim 12, wherein the enhanced content further comprises a message, image, or icon for display in association with the first action item, and the message, image, or icon represents an option to purchase the alternative item.

14. The system of claim 4, wherein determining the budgetary classification further comprises generating an on-sale determination, and generating the on-sale determination includes determining that the first action item is on sale or that a coupon is available to reduce the price of the first action item.

15. A method for visualizing one or more in-budget products or services, comprising:
storing profile data comprising user profile information;
receiving from a computing device associated with the stored profile data, environmental data comprising audio and visual information representing a physical environment;
identifying one or more action items in the environmental data, the one or more action items being associated with one or more products or services in the physical environment;
determining a budgetary classification of a first action item of the one or more action items based on the profile data;
generating, based on the environmental data and determined budgetary classification, virtual environmental data comprising enhanced content associated with the first action item, wherein the enhanced content is unrepresented in the physical environment; and
providing, to the computing device, the virtual environmental data to create an augmented environment in combination with the physical environment, wherein the enhanced content is provided to the computing device for display in association with the first action item.

16. The method of claim 15, wherein the stored profile data includes the user budget information.

17. The method of claim 16, wherein the user budget information includes data indicative of a maximum amount of money that may be spent on items corresponding to the one or more action items and one or more of a predetermined time limit, a predetermined merchant, or a predetermined physical location.

18. The method of claim 16, wherein the user budget information includes data indicative of a maximum amount of money that may be spent on one or more item classes of a plurality of item classes, the one or more action items each corresponding to one of the plurality of item classes.

19. The method of claim 16, wherein determining the budgetary classification further comprises generating an in-budget determination, and generating the in-budget determination includes determining that a price associated with the first action item exceeds or fails to exceed a predetermined threshold associated with the user budget information.

20. The method of claim 20, wherein the enhanced content further comprises an icon for display in association with the first action item.

21. A system for visualizing one or more in-budget products or services, comprising:
one or more processors; and
a memory in communication with the one or more processors and storing instructions that, when executed by the one or more processors, are configured to cause the system to:
store profile data comprising user profile information;
receive, from a computing device associated with a merchant, virtual environmental data;
identify one or more action items in the virtual environmental data, the one or more action items being associated with one or more products or services;
determine a budgetary classification of a first action item of the one or more action items based on the profile data;
generate, based on the determined budgetary classification, enhanced content associated with the first action item, wherein the enhanced content is unrepresented in the virtual environmental data as received; and
provide, to a computing device associated with the user profile information, the virtual environmental data to create a virtual environment, wherein the enhanced content is provided to the computing device for display in association with the first action item.

22. The system of claim 21, wherein the stored profile data includes the user budget information.

23. The system of claim 21, wherein determining the budgetary classification further comprises generating an in-budget determination, and generating the in-budget determination includes determining that a price associated with the first action item exceeds or fails to exceed a predetermined threshold associated with the user budget information.

24. A method for visualizing one or more in-budget products or services, comprising:
storing profile data comprising user profile information;
receiving environmental data comprising audio and/or visual information representing an environment;
receiving merchant data from a merchant database;
identifying one or more action items in the environment, the one or more action items being associated with one or more products or services;
associate merchant data with the one or more action items;
determine a budgetary classification of a first item of the one or more action items based on the profile data and merchant data;
integrate the merchant data with the environmental data to create augmented environmental data comprising enhanced content associated with the first action item, where the enhanced content is unrepresented in the environmental data and the enhanced content is generated based on the budgetary classification of the first item; and
output the augmented environmental data for display.
